(19) United States
(12) Patent Application Publication
(10) Pub. No.: US 2010/0002148 A1
(43) Pub. Date: Jan. 7, 2010

(54) IMAGE SIGNAL PROCESSING APPARATUS, IMAGE SIGNAL PROCESSING METHOD, COMPUTER PROGRAM, AND DISPLAY DEVICE

(75) Inventors: Masayuki Otawara, Yokohama (JP); Hidehito Ogawa, Yokohama (JP); Ryutaro Okamoto, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/497,817

(22) Filed: Jul. 6, 2009

(30) Foreign Application Priority Data
Jul. 4, 2008 (JP) 2008-175361

(51) Int. Cl. H04N 5/52; H04N 5/66

(52) U.S. Cl. 348/678; 348/739; 348/E05.115; 348/E05.133

(57) ABSTRACT

An image signal processing apparatus and method of controlling the light emission state of each pixel in a display device are provided. The image signal processing apparatus includes a correlation determination unit which determines a correlation between a current frame and a previous frame, and outputs a correlation signal of a signal level according to a determination result; a light emission time setting unit which outputs a light emission time control signal that defines a light emission time in one frame period, based on the correlation signal; an adjustment value setting unit which outputs an adjustment value that adjusts a gain of the image signal, based on the correlation signal; and a gain adjustment unit which adjusts the gain of the image signal based on the adjustment value and outputs the image signal of which the gain is adjusted. The light emission intensity is uniform regardless of the determination result.

### CROSS-REFERENCE TO RELATED PATENT APPLICATION

This application claims priority from Japanese Patent Application No. 2008-175361, filed on Jul. 4, 2008, in the Japanese Intellectual Property Office, the disclosure of which is incorporated herein by reference in its entirety.

### BACKGROUND OF THE INVENTION

1. Field of the Invention

Apparatuses and methods consistent with the present invention relate to an image signal processing apparatus, an image signal processing method, a computer program, and a display device.

2. Description of the Related Art

In order to replace a cathode ray tube (CRT) display device, various display devices such as an organic electroluminescence (EL) display device (also referred to as an organic light-emitting diode (OLED) display device), a field emission display (FED) device, a liquid crystal display (LCD) device, and a plasma display panel (PDP) display device have been developed. Light emission of the display devices is mainly divided into an impulse type and a hold type. For example, the CRT display device and the FED device display an image by using the impulse type light emission and the LCD device displays an image by using the hold type light emission to continuously emit light for one frame period.

Also, a display device using the impulse type light emission has a display characteristic different from that of a display device using the hold type light emission. For example, the display device using the impulse type light emission emits light intermittently, has a moving image characteristic, and thus a phenomenon of creating a residual image of a previous frame, which is called as a motion residual image (a viewer does not experience motion residual images), rarely occurs. However, the display device using the impulse type light emission easily flickers. On the other hand, the display device using the hold type light emission continuously displays the same image for one frame period and rarely flickers, however easily creates motion residual images.

In this situation, a technology for improving image quality by suppressing flickers or motion residual images has been developed. For example, Japanese Patent Publication No. 2006-330664 (Cited Reference 1) discloses a technology for suppressing flickers by emitting light twice in one frame period, Japanese Patent Publication No. 2006-317894 (Cited Reference 2) discloses a technology for suppressing flickers by emitting light from every two scan lines in one frame period, and Japanese Patent Publication No. 2006-165974 (Cited Reference 3) discloses a technology for suppressing double images by generating an interpolation frame during when a moving image is displayed.

However, in a display device using a conventional flicker suppressing method, light is generally emitted a plurality of times (for example, twice) in one frame period without being based on an input image signal and thus a user may experience a double image according to the input image signal due to a residual image effect on the eyes of the user. An exemplary problem of the display device using the flicker suppressing method in the related art will now be described with reference to FIGS. 9A and 9B.

FIGS. 9A and 9B are images for describing a problem of a display device using a flicker suppressing method in the related art.

FIG. 9A illustrates a case when the display device displays a letter X on a screen as a still image and FIG. 9B illustrates a case when the display device displays the letter X on the screen as a moving image.

In the still image illustrated in FIG. 9A, that is, in a case when images displayed in previous and current frame periods are the same, since the display device using the flicker suppressing method in the related art emits light a plurality of times in one frame period, a display location of the letter X does not change and thus a serious problem does not occur.

However, in the moving image illustrated in FIG. 9B, that is, in a case when the display location of the letter X in the previous frame period is different from that in the current frame period, a user recognizes the letter X in the previous frame period as a residual image due to a residual image effect on the eyes of the user (that is, the letter X is viewed as a double image). Thus, the display device using the flicker suppressing method in the related art may not improve image quality sufficiently.

Although a technology for suppressing double images that obstruct image quality improvement has been developed, due to the difficulty of forming an interpolation frame, a displayed image greatly deteriorates if the interpolation frame is not appropriately formed (for example, if the interpolation frame is formed to deteriorate a moving image for representing images of previous and current frames).

In more detail, in the double image suppressing technology in the related art, high costs are incurred in order to increase the accuracy of the interpolation frame. Thus, a display device using the double image suppressing technology in the related art may not improve image quality sufficiently.

Also, in a display device using a hold type light emission method, such as an LCD device, due to the principal of light emission, a motion residual image easily occurs. Thus, for example, a method similar to a double image suppressing method in the related art is used to suppress the motion residual image.

In more detail, in the display device using the hold type light emission method, for example, the motion residual image is suppressed by emitting light twice in one frame period and interpolating a frame corresponding to the second light emission from previous and current frames. However, like the double image suppressing technology in the related art, the motion residual image suppressing technology in the display device using the hold type light emission method in the related art may fail to form an interpolation frame due to the difficulty of forming the interpolation frame. Thus, the motion residual image suppressing technology in the display device using the hold type light emission method in the related art, which prevents the motion residual image by forming the interpolation frame, may not improve image quality sufficiently.

The above methods in the related art of improving image quality by suppressing flickers, double images, or motion residual images may not improve image quality sufficiently.

### SUMMARY OF THE INVENTION

The present invention provides a new and improved image signal processing apparatus, an image signal processing method, a computer program, and a display device, which may improve image quality by determining a correlation between current and previous frames based on an input image signal and controlling a gain of the image signal and a light emission time based on the determined correlation.

According to an aspect of the present invention, there is provided an image signal processing apparatus including a correlation determination unit which determines a correlation between a current frame, which represents an input image signal, and a previous frame in each of a plurality of pixels, and outputs a correlation signal of a signal level according to a determination result; a light emission time setting unit which outputs a light emission time control signal that defines a light emission time in one frame period, based on the correlation signal; an adjustment value setting unit which outputs an adjustment value that adjusts a gain of the image signal, based on the correlation signal; and a gain adjustment unit which adjusts the gain of the image signal based on the adjustment value and outputs the image signal of which the gain is adjusted, wherein the light emission intensity in one frame period, which is defined by a product of a light emission time corresponding to the light emission time control signal and a signal level corresponding to the image signal output from the gain adjustment unit, is uniform regardless of the determination result of the correlation determination unit.

In the above structure, image quality may be improved by determining a correlation between current and previous frames based on an input image signal and controlling a gain of the image signal and a light emission time based on the determined correlation.

The correlation determination unit may include a frame memory which stores the input image signal in one frame period; and a comparison unit which compares an image signal corresponding to the current frame to an image signal corresponding to the previous frame output from the frame memory, in each of the pixels, and outputs the correlation signal according to a comparison result.

In the above structure, a correlation between current and previous frames may be determined and a correlation signal of a signal level according to a determination result may be output. Thus, image quality may be improved by determining a correlation between current and previous frames based on an input image signal and controlling a gain of the image signal and a light emission time based on the determined correlation.

According to another aspect of the present invention, there is provided an image signal processing method including determining a correlation between a current frame, which represents an input image signal, and a previous frames, in each of a plurality of pixels, and outputting a correlation signal of a signal level according to a determination result; outputting a light emission time control signal that defines a light emission time in one frame period, based on the correlation signal; outputting an adjustment value that adjusts a gain of the image signal, based on the correlation signal; and adjusting the gain of the image signal based on the adjustment value and outputting the image signal of which the gain is adjusted.

In the above method, image quality may be improved by determining a correlation between current and previous frames based on an input image signal, and controlling a gain of the image signal and a light emission time based on the determined correlation.

According to another aspect of the present invention, there is provided a computer-readable medium encoded with a computer program for causing a computer to execute an image signal processing method including determining a correlation between a current frame, which represents an input image signal, and a previous frame, in each of a plurality of pixels, and outputting a correlation signal of a signal level according to a determination result; outputting a light emission time control signal that defines a light emission time in one frame period, based on the correlation signal; outputting an adjustment value that adjusts a gain of the image signal, based on the correlation signal; and adjusting the gain of the image signal based on the adjustment value and outputting the image signal of which the gain is adjusted.

Implementing the above computer program, image quality may be improved by determining a correlation between current and previous frames based on an input image signal and controlling a gain of the image signal and a light emission time based on the determined correlation.

Furthermore, examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like.

According to another aspect of the present invention, there is provided a display device including an image signal adjustment unit which adjusts a gain of an image signal and a light emission time in one frame period, based on an input image signal; and an image display unit having at least one pixel that includes a light emission element that emits light itself according to a current, and displays an image based on the image signal and a light emission time control signal that defines the light emission time, wherein the image signal and the light emission time control signal are output from the image signal adjustment unit, wherein the image signal adjustment unit includes a correlation determination unit which determines a correlation between a current, which represents an input image signal, and a previous frame, in each of a plurality of pixels, and outputs a correlation signal of a signal level according to a determination result; a light emission time setting unit which outputs the light emission time control signal based on the correlation signal; an adjustment value setting unit which outputs an adjustment value that adjusts the gain of the image signal, based on the correlation signal; and a gain adjustment unit which adjusts the gain of the image signal based on the adjustment value and outputs the image signal of which the gain is adjusted, and wherein the light emission intensity in one frame period, which is defined by the light emission time control signal and the image signal output from the gain adjustment unit, is uniform regardless of the determination result of the correlation determination unit.

In the above structure, image quality may be improved by determining a correlation between current and previous frames based on an input image signal and controlling a gain of the image signal and a light emission time based on the determined correlation.

### BRIEF DESCRIPTION OF THE DRAWINGS

The above and/or other aspects of the present invention will become more apparent by describing in detail exemplary embodiments thereof with reference to the attached drawings in which:

FIGS. 1A and 1B are a first set of graphs for describing an approach to control a gain of an image signal and a light emission time, according to an exemplary embodiment of the present invention;

FIGS. 2A through 2D are a second set of graphs for describing an approach to control a gain of an image signal and a light emission time, according to an exemplary embodiment of the present invention;

FIG. 3 is a block diagram of an image signal processing apparatus according to an exemplary embodiment of the present invention;

FIG. 4 is a block diagram of a correlation determination unit illustrated in FIG. 3, according to an exemplary embodiment of the present invention;

FIG. 5 is a conceptual diagram of an adjustment value setting unit illustrated in FIG. 3, according to an exemplary embodiment of the present invention;

FIG. 6 is a conceptual diagram of a light emission time setting unit illustrated in FIG. 3, according to an exemplary embodiment of the present invention;

FIG. 7 is a flowchart of an image signal processing method according to an exemplary embodiment of the present invention;

FIG. 8 is a block diagram of a display device according to an exemplary embodiment of the present invention; and

FIGS. 9A and 9B are images for describing a problem of a display device using a flicker suppressing method in the related art.

### DETAILED DESCRIPTION OF THE INVENTION

Hereinafter, the present invention will be described in detail by explaining exemplary embodiments of the invention with reference to the attached drawings. Like reference numerals in the drawings denote like elements and thus repeated descriptions will be omitted.

### Approach to Control Gain of Image Signal and Light Emission Time, According to an Exemplary Embodiment of the Present Invention

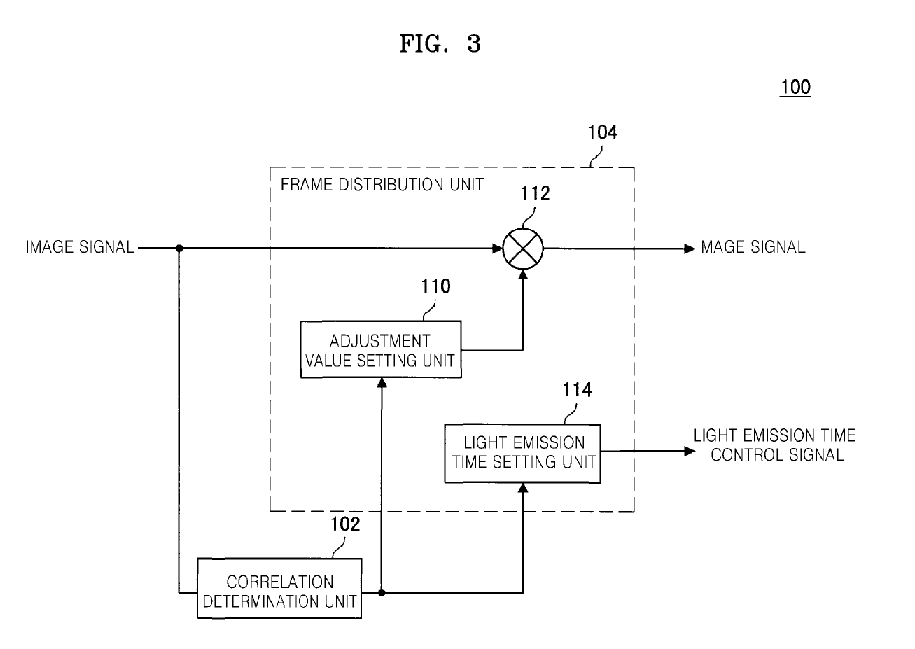

Before describing an image signal processing apparatus according to an exemplary embodiment of the present invention (hereinafter referred to as an image signal processing apparatus 100 (see FIG. 3)), an approach to control a gain of an image signal and a light emission time, according to an exemplary embodiment of the present invention, will now be described.

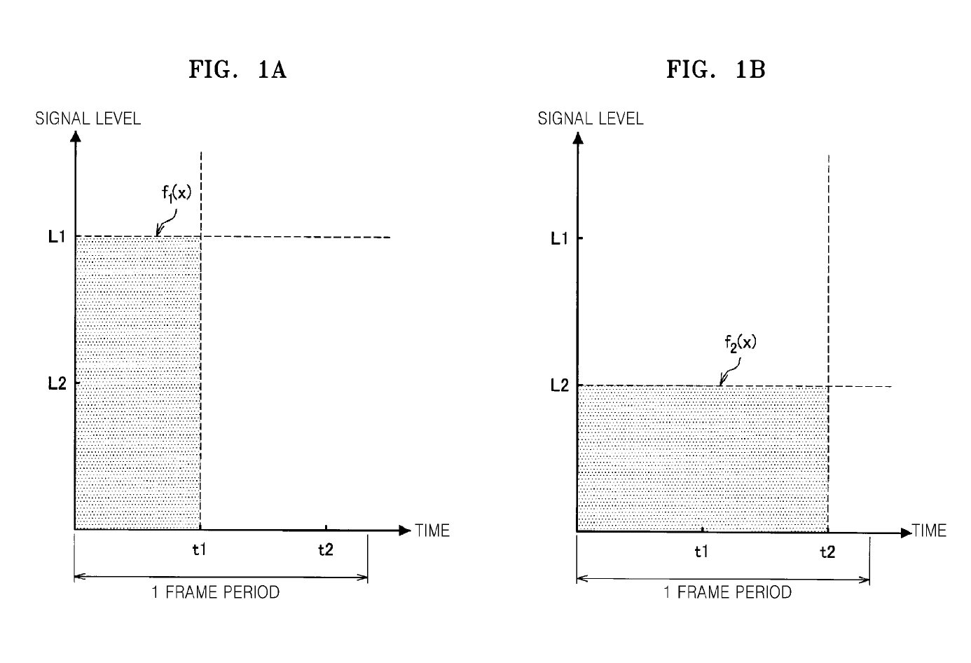

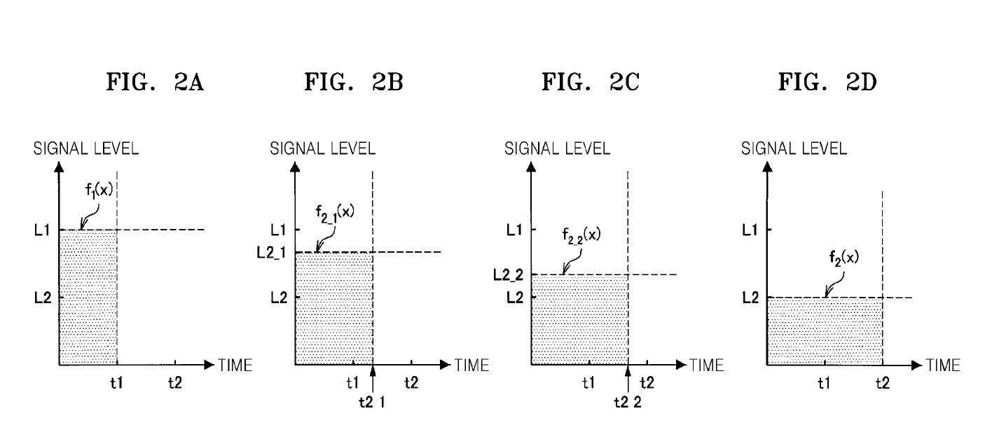

FIGS. 1A and 1B are a first set of graphs for describing an approach to control a gain of an image signal and a light emission time, according to an exemplary embodiment of the present invention. FIGS. 2A through 2D are a second set of graphs for describing the control approach.

Referring to FIGS. 1A and 1B, a vertical axis represents a signal level (L) of the image signal and a horizontal axis represents the light emission time. FIG 1A illustrates an impulse type light emission state. In FIG. 1A, the signal level is L1, the light emission time is t1, and thus the light emission intensity is L1×t1. FIG. 1B illustrates a hold type light emission state. In FIG. 1B, the signal level is L2 (L2<L1), the light emission time is t2 (t2>t1), and thus the light emission intensity is L2×t2.

Here, if the light emission intensity in FIG. 1A is equal to the light emission intensity in FIG. 1B, that is, if L1×t1=L2×t2, a correlation between the light emission intensities in FIGS. 1A and 1B is represented as shown in Equation 1.

∫₀^{t1}f₁(x)dt=∫₀^{t2}f₂(x)dt (1)

If the correlation of Equation 1 is true, that is, if the light emission intensities are equal to each other, due to the integral effect for human eyes, the impulse type light emission state illustrated in FIG. 1A and the hold type light emission state illustrated in FIG. 1B are viewed as images having the same brightness. Thus, if the same light emission intensity is maintained, although the impulse type light emission state and the hold type light emission state switch one another, a gray scale is not affected and thus image quality does not deteriorate.

With reference to FIGS. 1A and 1B, it can be seen that a gray scale is not affected if the correlation of Equation 1 is true even when the impulse type light emission state (FIG. 1A) and the hold type light emission state (FIG. 1B) switch one another. However, the control approach is not limited to the two different states illustrated in FIGS. 1A and 1B. For example, the image signal processing apparatus 100 may change the gain of the image signal and the light emission time into three or more states as illustrated in FIGS. 2A through 2D. Here, FIG. 2A illustrates the impulse type light emission state illustrated in FIG. 1A, FIG. 2D illustrates the hold type light emission state illustrated in FIG. 1B, and FIGS. 2B and 2C illustrate intermediate light emission states between the impulse type light emission state (FIG. 1A) and the hold type light emission state (FIG. 1B).

By changing the gain of the image signal and the light emission time into three or more states as illustrated in FIGS. 2A through 2D, the image signal processing apparatus 100 may realize various light emission states. Also, although a light emission state is changed as illustrated in FIGS. 2A through 2D, if the gain of the image signal and the light emission time are controlled to have the same light emission intensity in the different states as shown in Equation 2, the gray scale is not affected and thus the image quality does not deteriorate.

∫₀^{t1}f₁(x)dt=∫₀^{t2}^{_{—}}¹f₂_{_{—}}₁(x)dt=∫₀^{t2}^{_{—}}²f₂_{_{—}}₂(x)dt=∫₀^{t2}f₂(x)dt (2)

In consideration of the correlations of Equations 1 and 2, the image signal processing apparatus 100 prevents flickers and motion residual images by controlling the gain of the image signal and the light emission time according to, for example, processing operations (1) through (3) to be described below.

(1) Determination of Correlation Between Current and Previous Frames

The image signal processing apparatus 100 determines a correlation between a frame on which an image represented by an input image signal is displayed (hereinafter referred to as a current frame) and a frame in one frame period before the current frame (hereinafter referred to as a previous frame). By determining the correlation between the current and previous frames, the image signal processing apparatus 100 may determine whether a subject (for example, a person, an animal, or an object such as a car) included in the image represented by the image signal is fixed or moves. Also, by determining a correlation strength between the current and previous frames (hereinafter referred to as a correlation level), the image signal processing apparatus 100 may further determine a degree of motion of the subject.

As such, by determining the correlation level, the image signal processing apparatus 100 may display the image on a display screen in a light emission state corresponding to the correlation strength. For example, if the correlation level has a maximum value (i.e., if the correlation strength is the highest), the image has a high possibility of being a still image, and thus, the image signal processing apparatus 100 displays the image in the hold type light emission state illustrated in FIG. 2D. On the other hand, if the correlation level has a minimum value (i.e., if the correlation strength is the lowest), the image has a high possibility of being a moving image in which a subject greatly moves, and thus, the image signal processing apparatus 100 displays the image in the impulse type light emission state illustrated in FIG. 2A. If the correlation level has an intermediate value between the minimum and maximum values, the image signal processing apparatus 100 displays the image in the intermediate light emission state illustrated in FIG. 2B or FIG. 2C according to the correlation level. As such, by controlling the light emission state according to the correlation level, the image signal processing apparatus 100 may realize various light emission states. A method of controlling a light emission state according to a correlation level, according to an embodiment of the present invention, will be described later.

For example, based on an input image signal (an image signal corresponding to the current frame) and an image signal corresponding to the previous frame, the image signal processing apparatus 100 determines the correlation level in each pixel corresponding to a display location of the display screen on which the image is displayed. Here, for example, a method of obtaining a differential value (or an absolute value of the differential value) in each pixel between the image signal of the previous frame and the image signal of the current frame may be used as a correlation level determination method, however, the present invention is not limited thereto. For example, the image signal processing apparatus 100 may detect a motion vector and derive the correlation level based on the size of the motion vector.

Also, the image signal processing apparatus 100 may divide the display screen into a plurality of separate regions and may determine the correlation level in each separate region. In this case, the image signal processing apparatus 100 determines the correlation level in each pixel included in a separate region and outputs the most frequent determination result as the determination result of the separate region. However, the correlation level determination method of the image signal processing apparatus 100 is not limited thereto.

(2) Output of Correlation Signal of Signal Level According to Determination Result (Correlation Level)

Based on the correlation level determined in the processing operation (1), the image signal processing apparatus 100 outputs a correlation signal of a signal level according to the correlation level. Here, for example, the image signal processing apparatus 100 may uniquely output the correlation signal of the signal level according to the correlation level by using a look-up table in which the correlation level corresponds to the signal level of the correlation signal, however, the present invention is not limited thereto.

(3) Control of Gain of Image Signal and Light Emission Time Based on Correlation Signal

Based on the correlation signal output in the processing operation (2), the image signal processing apparatus 100 controls the gain of the image signal and the light emission time. The control of the gain of the image signal based on the correlation signal and the control of the light emission time based on the correlation signal will now be separately described. However, the image signal processing apparatus 100 may synchronously control the gain of the image signal and the light emission time.

### (3-1) Control of Gain of Image Signal

Based on the correlation signal, the image signal processing apparatus 100 outputs an adjustment signal in each pixel according to the signal level of the correlation signal. Then, for example, the image signal processing apparatus 100 adjusts a gain of an input image signal by multiplying the input image signal by the adjustment signal. In this case, the adjustment signal functions as a multiplication coefficient for adjusting the gain of the image signal. An adjustment signal output method of the image signal processing apparatus 100 will be described later.

### (3-2) Control of Light Emission Time

Based on the correlation signal, the image signal processing apparatus 100 outputs a light emission time control signal according to the signal level of the correlation signal. Here, the light emission time control signal is a signal for defining the light emission time in one frame period. A light emission time control signal output method of the image signal processing apparatus 100 will be described later.

As described above in the processing operations (3-1) and (3-2), the image signal processing apparatus 100 may adjust (control) the gain of the image signal and may control the light emission time by separately outputting the adjustment signal and the light emission time control signal based on the correlation signal.

An example of a correlation between the gain of the image signal and the light emission time which are controlled based on the correlation signal by the image signal processing apparatus 100 will now be described.

[Example of Correlation between Gain of Image Signal and Light Emission Time which are Controlled Based on Correlation Signal]
(I) Case When Correlation Signal Corresponds to Maximum Value of Correlation Level: Case When Possibility of being Still Image is High

If the correlation signal output in the processing operation (2) corresponds to a maximum value of the correlation level, the possibility of being a still image is high. Thus, the image signal processing apparatus 100 selects, for example, hold type light emission. Then, the image signal processing apparatus 100 controls the gain of the image signal and the light emission time to obtain the hold type light emission state as illustrated in FIG. 2D.

Here, since the possibility of creating motion residual images is low when a still image is displayed, in this case, the image signal processing apparatus 100 prevents flickers by selecting the hold type light emission. Thus, the image signal processing apparatus 100 may prevent flickers and motion residual images.

Also, for example, the phase alternating line (PAL) standard adopted in European counties uses a frame period of 50 Hz lower than 59.94 Hz, which is the frame period used in the national television standards committee (NTSC) standard, and thus flickers may be created more easily in the PAL standard. However, even if an image signal according to the PAL standard is input, if a still image is displayed (i.e., if the correlation level has a maximum value), the image signal processing apparatus 100 may select the hold type light emission and thus may prevent flickers.

(II) Case When Correlation Signal Corresponds to Minimum Value of Correlation Level: Case When Possibility of being Moving Image in which Subject Greatly Moves is High

If the correlation signal output in the processing operation (2) corresponds to a minimum value of the correlation level, the possibility of being a moving image in which a subject greatly moves is high. Thus, the image signal processing apparatus 100 selects, for example, impulse type light emission. Then, the image signal processing apparatus 100 controls the gain of the image signal and the light emission time to obtain the impulse type light emission state illustrated in FIG. 2A.

Since the possibility of creating flickers is low when a moving image in which a subject greatly moves is displayed, in this case, the image signal processing apparatus 100 prevents motion residual images by selecting the impulse type light emission. Thus, the image signal processing apparatus 100 may prevent flickers and motion residual images.

(III) Case When Correlation Signal Corresponds to Intermediate Value between Minimum and Maximum Values of Correlation Level: Other Cases

If the correlation signal output in the processing operation (2) corresponds to an intermediate value between minimum and maximum values of the correlation level, the image signal processing apparatus 100 controls the gain of the image signal and the light emission time according to the signal level of the correlation signal. For example, if the correlation signal output in the processing operation (2) corresponds to an intermediate value closer to the maximum value of the correlation level, the image signal processing apparatus 100 controls the gain of the image signal and the light emission time to obtain the intermediate light emission state, as illustrated in FIG. 2C, and thus prevent flickers rather than motion residual images. Otherwise, if the correlation signal output in the processing operation (2) corresponds to an intermediate value closer to the minimum value of the correlation level, the image signal processing apparatus 100 controls the gain of the image signal and the light emission time to obtain the intermediate light emission state, as illustrated in FIG. 2B, and thus prevent motion residual images rather than flickers.

For example, as described above in the cases (I) through (III), the image signal processing apparatus 100 controls the gain of the image signal and the light emission time based on the correlation signal. Thus, the image signal processing apparatus 100 may realize various light emission states according to the signal level of the correlation signal (i.e., according to the correlation level).

The image signal processing apparatus 100 may control a gain of an image signal and a light emission time based on a correlation between current and previous frames by performing, for example, the processing operations (1) through (3). Thus, the image signal processing apparatus 100 may prevent flickers and motion residual images.

The structure of the image signal processing apparatus 100 for performing the processing operations (1) through (3) will now be described.

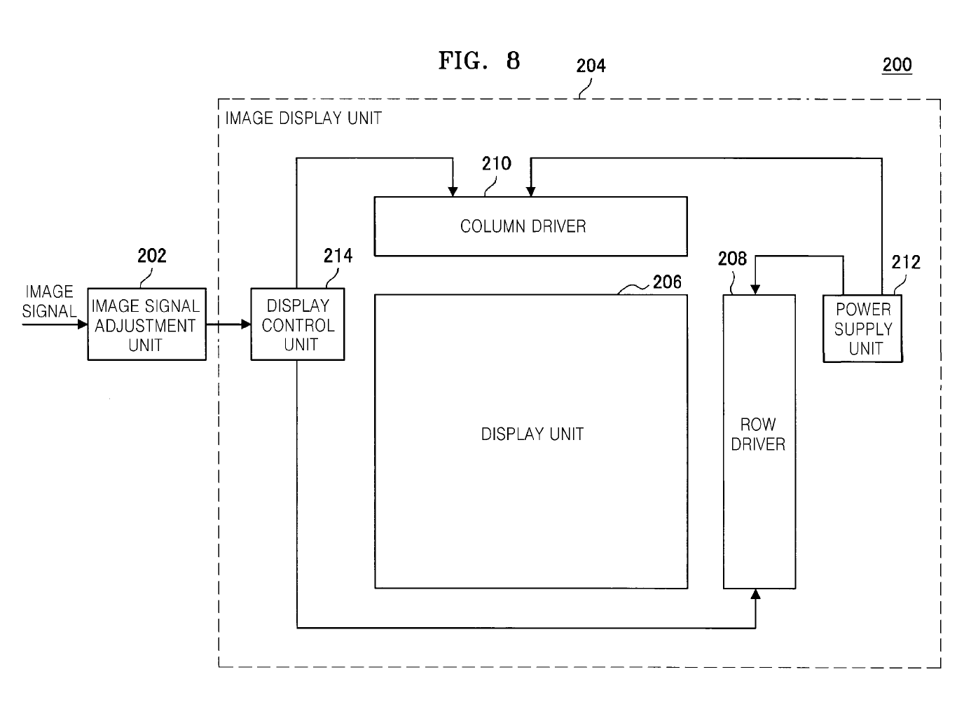

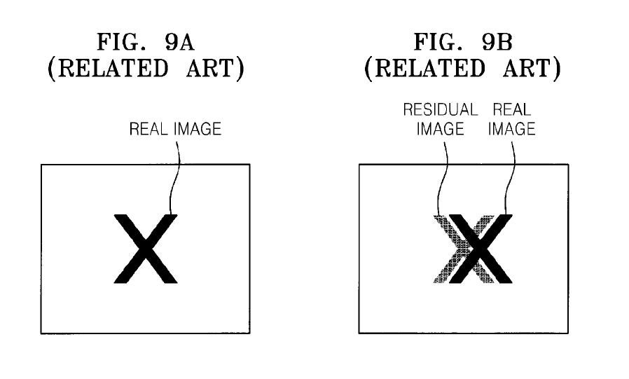

In the following description, an organic electroluminescence (EL) display device, which is a self-emission type display device for emitting light according to a current flowing in a light emission element included in the organic EL display device, will be representatively described as a display device for displaying an image signal output from the image signal processing apparatus 100, according to an exemplary embodiment of present invention (hereinafter referred to as a display device 200 (see FIG. 8)). Here, an organic EL element, that is, a light emission element included in the organic EL display device, has a linear current-light emission intensity (IL) characteristic, and thus, light is emitted according to the current applied to the light emission element. Thus, if the organic EL display device is used as the display device 200 for displaying the image signal output from the image signal processing apparatus 100, a linear correlation may be formed between the light intensity of a subject, which is represented by the image signal output from the image signal processing apparatus 100, and the light emission intensity of light emitted from the light emission element of the display device 200, and thus, an image may be displayed reliably for the image signal.

The display device 200 for displaying the image signal output from the image signal processing apparatus 100 is not limited to the organic EL display device. For example, the display device 200 for displaying the image signal output from the image signal processing apparatus 100 may be a display device such as a liquid crystal display (LCD) device, which may emit light according to a current or a voltage applied to a light emission element included in the LCD device.

### (Image Signal Processing Apparatus 100)

FIG. 3 is a block diagram of an image signal processing apparatus 100 according to an exemplary embodiment of the present invention.

Here, although one image signal is illustrated in FIG. 3, the present invention is not limited thereto. For example, red (R), green (G), and blue (B) image signals may be independently input to the image signal processing apparatus 100.

Also, although it is assumed in the following description that the image signal input to the image signal processing apparatus 100 is, for example, a digital signal to be used for digital broadcasting, the present invention is not limited thereto. The image signal may also be, for example, an analog signal used for analog broadcasting. If the image signal is an analog signal, the image signal processing apparatus 100 may include, for example, an analog-to-digital (A/D) converter (not shown) in a front portion of the structure illustrated in FIG. 3. Furthermore, the image signal input to the image signal processing apparatus 100 may be, for example, a signal transmitted from a broadcasting station and received by the image signal processing apparatus 100, however is not limited thereto. For example, the image signal input to the image signal processing apparatus 100 may be a signal transmitted from an external device through a network such as a local area network (LAN) and received by the image signal processing apparatus 100, or may be an image file stored in a memory unit (not shown) included in the image signal processing apparatus 100 and read by the image signal processing apparatus 100.

Referring to FIG. 3, the image signal processing apparatus 100 includes a correlation determination unit 102 and a frame distribution unit 104. Signal processing in the correlation determination unit 102 and the frame distribution unit 104 may be performed by using, for example, hardware (e.g., a signal processing circuit) and/or software (signal processing software).

Also, the image signal processing apparatus 100 may include, for example, a control unit (not shown) such as a micro processing unit (MPU) for controlling the whole image signal processing apparatus 100, a read only memory (ROM) (not shown) for recording therein a computer program or control data, such as operation parameters, which is used by the control unit, a random access memory (RAM) (not shown) for primarily recording the computer program to be executed by the control unit, a reception unit (not shown) for receiving an image signal transmitted from, for example, a broadcasting station, a memory unit (not shown) for recording image files, a manipulation unit (not shown) to be manipulated by a user, and a communication unit (not shown) for communicating with an external device (not shown). The image signal processing apparatus 100 accesses each of the above components via, for example, a data transmission line such as a bus.

Here, the memory unit may be, for example, a magnetic recording medium such as a hard disk, nonvolatile memory such as electrically erasable and programmable read only memory (EEPROM), flash memory, magnetoresistive random access memory (MRAM), ferroelectric random access memory (FeRAM), or phase change random access memory (PRAM), or a magneto optical disk, however is not limited thereto. Also, the manipulation unit may be, for example, a manipulation input device such as a keyboard or a mouse, buttons, direction keys, or a combination thereof, however is not limited thereto.

Also, the image signal processing apparatus 100 and the external device may be physically connected to each other, for example, by using a universal serial bus (USB) connection or according to the Institute of Electrical and Electronics Engineers (IEEE) 1394 standard, or may be wirelessly connected to each other, for example, by using a wireless universal serial bus (WUSB) connection or according to the IEEE 802.11 standard. Furthermore, the image signal processing apparatus 100 and the external device may be connected to each other, for example, through a network. The network may be, for example, a wired network such as a LAN or a wide area network (WAN), a wireless network such a wireless local area network (WLAN) using multiple-input multiple-output (MIMO) technology, or the Internet using a communication protocol such as a transmission control protocol/Internet protocol (TCP/IP), however is not limited thereto. Thus, the communication unit has an interface according to a connection method with the external device.

Based on an input image signal, the correlation determination unit 102 determines a correlation between current and previous frames in each pixel corresponding to a display location of a display screen on which an image is displayed. Then, the correlation determination unit 102 outputs a correlation signal of a signal level according to a determined correlation level. In more detail, the correlation determination unit 102 performs the processing operation by (1) determining the correlation between the current and previous frames, and (2) outputting the correlation signal of the signal level according to the determination result (correlation level).

### [Exemplary Structure of Correlation Determination Unit 102]

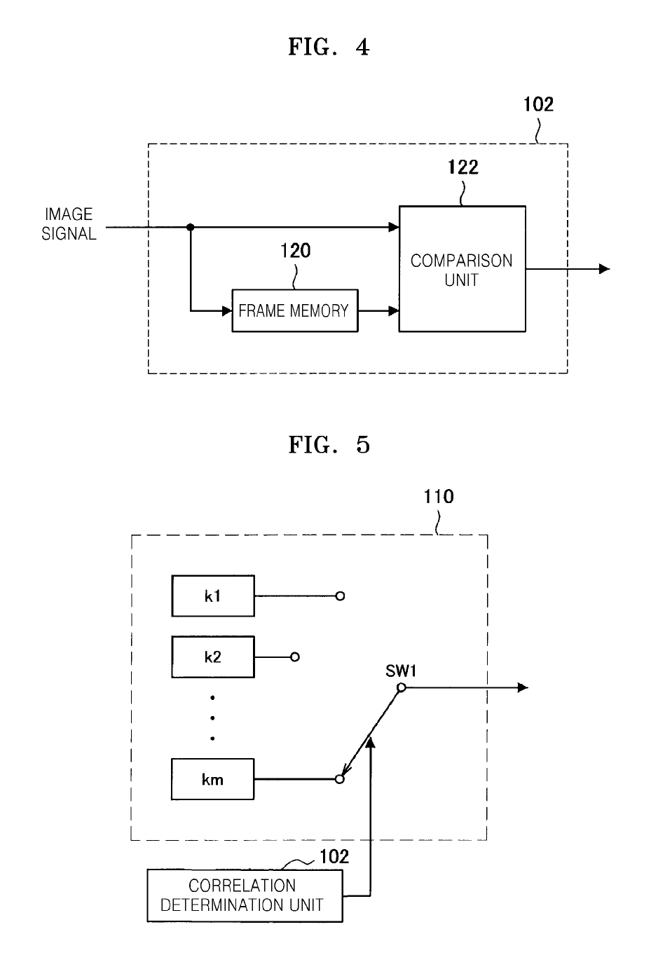

FIG. 4 is a block diagram of the correlation determination unit 102 illustrated in FIG. 3.

Referring to FIG. 4, the correlation determination unit 102 includes a frame memory 120 and a comparison unit 122.

The frame memory 120 stores an image signal in one frame period (i.e., an image for one screen). That is, the frame memory 120 may store the image signal corresponding to a previous frame.

Based on an input image signal (an image signal corresponding to a current frame) and an image signal corresponding to the previous frame stored by the frame memory 120, the comparison unit 122 determines a correlation level in each pixel corresponding to a display location of a display screen on which an image is displayed. Here, for example, the comparison unit 122 may obtain an absolute value of a differential value between the image signal of the previous frame and the image signal of the current frame in each pixel and may determine the correlation level according to the size of the absolute value of the differential value. For example, if the absolute value of the differential value in a pixel is zero, the possibility that images of previous and current frames in a pixel are the same (i.e., the possibility of being a still image) is high. On the other hand, if the absolute value of the differential value in a pixel is not zero, as the absolute value of the differential value is high, motion of a subject in a moving image increases. As such, by determining the correlation level in each pixel, the comparison unit 122 may determine whether an image represented by the input image signal is a still image or a moving image and may also determine the degree of motion of a subject in the image. However, the correlation level determination method of the comparison unit 122 is not limited thereto.

Based on the determined correlation level, the comparison unit 122 outputs a correlation signal of a signal level in each pixel according to the correlation level. Here, the comparison unit 122 may correspondingly output the correlation signal of the signal level according to the correlation level by using, for example, a look-up table in which the correlation level corresponds to the signal level of the correlation signal, however, the present invention is not limited thereto. The look-up table may be stored in, for example, a memory unit included in the comparison unit 122. The memory unit included in the comparison unit 122 may be, for example, nonvolatile memory such as EEPROM or flash memory, however is not limited thereto. Also, the comparison unit 122 may appropriately read the look-up table recorded in a memory unit (not shown) of the image signal processing apparatus 100.

As such, the correlation determination unit 102 may determine the correlation level and may output the correlation signal of the signal level in each pixel according to the determined correlation level.

Referring back to FIG. 3, the structure of the image signal processing apparatus 100 will be further described. Based on a correlation signal output from the correlation determination unit 102, the frame distribution unit 104 controls a gain of an image signal and a light emission time. That is, the frame distribution unit 104 performs the processing operation (3) (i.e., the control of the gain of the image signal and the light emission time based on the correlation signal).

### [Exemplary Structure of Frame Distribution Unit 104]

The frame distribution unit 104 includes an adjustment value setting unit 110, a gain adjustment unit 112, and a light emission time setting unit 114. Here, the adjustment value setting unit 110 and the gain adjustment unit 112 perform the processing operation (3-1) (i.e., the control of the gain of the image signal) and the light emission time setting unit 114 performs the processing operation (3-2) (i.e., the control of the light emission time).

### (1) Control of Gain of Image Signal

Based on the correlation signal output from the correlation determination unit 102, the adjustment value setting unit 110 outputs an adjustment signal in each pixel according to a signal level of a correlation signal.

FIG. 5 is a conceptual diagram of the adjustment value setting unit 110 illustrated in FIG. 3, according to an exemplary embodiment of the present invention. In FIG. 5, the correlation determination unit 102 for outputting the correlation signal is also illustrated.

Referring to FIG. 5, based on the correlation signal output from the correlation determination unit 102, the adjustment value setting unit 110 selectively outputs an adjustment value km (m is an integer equal to or greater than one) according to the signal level of the correlation signal. In FIG. 5, the adjustment value setting unit 110 includes a switch SW1 to be connected to a different value of a plurality of different values according to the correlation signal. However, the structure of the adjustment value setting unit 110 is not limited thereto. For example, the adjustment value setting unit 110 may correspondingly output the adjustment value km according to the signal level of the correlation signal by using a look-up table in which the adjustment value km corresponds to the signal level of the correlation signal. The look-up table may be stored in, for example, a memory unit included in the adjustment value setting unit 110. The memory unit included in the adjustment value setting unit 110 may be, for example, nonvolatile memory such as EEPROM or flash memory, however is not limited thereto. Also, the adjustment value setting unit 110 may appropriately read the look-up table stored in the memory unit of the image signal processing apparatus 100.

Referring back to FIG. 3, based on the input image signal and the adjustment value km in each pixel, which is received from the adjustment value setting unit 110, the gain adjustment unit 112 adjusts the gain of the image signal. In more detail, the gain adjustment unit 112 adjusts the gain of the image signal by, for example, multiplying the image signal by the adjustment value km received from the adjustment value setting unit 110. Here, the gain adjustment unit 112 may be, for example, a multiplier, however is not limited thereto.

As the gain adjustment unit 112 adjusts the gain of the image signal based on the adjustment value km according to the signal level of the correlation signal output from the correlation determination unit 102, the image signal processing apparatus 100 may control the gain of the image signal based on the correlation signal as described above in the processing operations (I) through (III).

### (2) Control of Light Emission Time

Based on the correlation signal output from the correlation determination unit 102, the light emission time setting unit 114 outputs a light emission time control signal according to the signal level of the correlation signal.

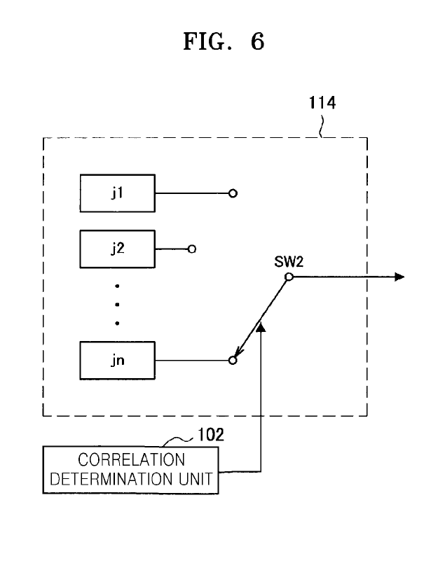

FIG. 6 is a conceptual diagram of the light emission time setting unit 114 illustrated in FIG. 3, according to an exemplary embodiment of the present invention. In FIG. 6, the correlation determination unit 102 for outputting the correlation signal is also illustrated.

Referring to FIG. 6, based on the correlation signal output from the correlation determination unit 102, the light emission time setting unit 114 selectively outputs a light emission time control signal jn (n is an integer equal to or greater than one) according to the signal level of the correlation signal. In FIG. 6, the light emission time setting unit 114 includes a switch SW2 to be connected to a different signal of a plurality of signals according to the correlation signal. However, the structure of the light emission time setting unit 114 is not limited thereto. For example, the light emission time setting unit 114 may uniquely output the light emission time control signal jn according to the signal level of the correlation signal by using a look-up table in which a signal level of the light emission time control signal jn corresponds to the signal level of the correlation signal. The look-up table may be stored in, for example, a memory unit included in the light emission time setting unit 114. However, the present invention is not limited thereto.

As the light emission time setting unit 114 outputs the light emission time control signal jn according to the signal level of the correlation signal output from the correlation determination unit 102, the image signal processing apparatus 100 may control the light emission time based on the correlation signal as described above in the processing operations (I) through (III).

As described above with reference to FIGS. 3 through 6, the image signal processing apparatus 100 performs the processing operation (1) (i.e., the determination of the correlation between the current and previous frames), the output operation (2) (i.e., the output of correlation signal of signal level according to determination result), and the processing operation (3) (i.e., the control of the gain of the image signal and the light emission time based on the correlation signal). Accordingly, the image signal processing apparatus 100 may prevent flickers and motion residual images and may improve image quality.

As such, the image signal processing apparatus 100 determines a correlation between current and previous frames based on an input image signal, and controls a gain of an image signal and a light emission time based on the determined correlation. Here, the image signal processing apparatus 100 controls a gain of an input image signal by using an adjustment value based on a correlation signal according to a determined correlation level. Also, the image signal processing apparatus 100 controls the light emission time in one frame period by outputting a light emission time control signal based on the correlation signal according to the determined correlation level. Furthermore, the image signal processing apparatus 100 controls the adjustment value and the light emission time control signal based on the correlation signal so that the light emission intensity in one frame period satisfies a correlation represented in Equation 2. As such, by controlling the gain of the image signal and controlling the light emission time based on the correlation signal, the image signal processing apparatus 100 may realize, for example, various light emission states described above in the processing operations (I) through (III) and thus may prevent flickers and motion residual images. Accordingly, the image signal processing apparatus 100 may improve image quality by determining a correlation between current and previous frames based on an input image signal and controlling a gain of the image signal and a light emission time based on the determined correlation.

Although the image signal processing apparatus 100 is described as an embodiment of the present invention, the present invention is not limited thereto. The image signal processing apparatus 100 of the present invention may be applied to, for example, a display device such as an organic EL display device or an LCD device, which includes a light emission element for emitting light according to a current or a voltage, a computer such as a personal computer (PC) or a server, or a portable communication device such as a mobile phone. Also, the image signal processing apparatus 100 may be realized as, for example, an integrated circuit (IC) chip on which the components illustrated in FIG. 3 are integrated. A case when the image signal processing apparatus 100 of the present invention is applied to a display device will be described later. (Computer Program for Image Signal Processing Apparatus 100)

A computer program encoded on a computer-readable medium and for allowing a computer to function as the image signal processing apparatus 100 may improve image quality by determining a correlation between current and previous frames based on an input image signal, and controlling a gain of the image signal and a light emission time based on the determined correlation.

### (Image Signal Processing Method)

An image signal processing method according to an exemplary embodiment of the present invention will now be described.

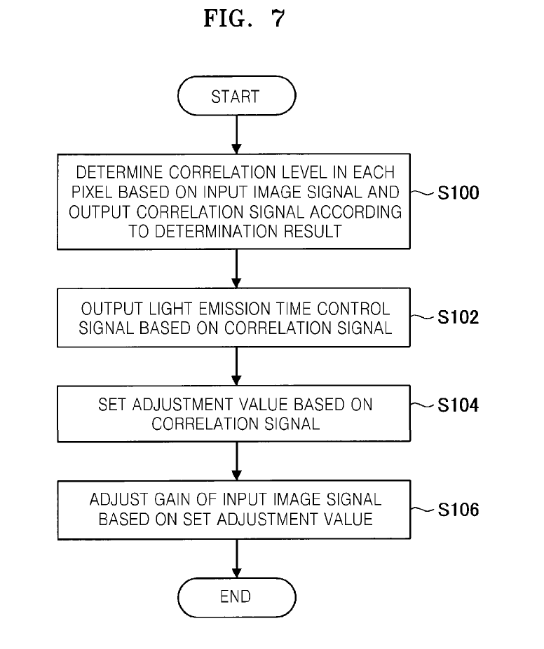

FIG. 7 is a flowchart of an image signal processing method according to an embodiment of the present invention. In the following description, it is assumed that the image signal processing method is performed by the image signal processing apparatus 100. However, the image signal processing method may also be applied to the display device 200, as will be described later. FIG. 7 will be described in conjunction with FIGS. 3 through 6.

Referring to FIG. 7, the image signal processing apparatus 100 determines a correlation level between current and previous frames in each pixel based on an input image signal, and outputs a correlation signal according to a determination result (the correlation level) (operation S100). Here, for example, the image signal processing apparatus 100 determines an absolute value of a differential value between a value of the input image signal (e.g., corresponding to an image signal of the current frame) and a value of an image signal stored in the frame memory 120 (e.g., corresponding to an image signal of the previous frame) in each pixel and determines a correlation level according to the size of the absolute value of the differential value. Also, the image signal processing apparatus 100 may uniquely output the correlation signal of a signal level according to the correlation level by using a look-up table in which the correlation level corresponds to the signal level of the correlation signal.

Based on the correlation signal output in operation S100, the image signal processing apparatus 100 outputs a light emission time control signal in each pixel according to the signal level of the correlation signal (operation S102). Here, for example, the image signal processing apparatus 100 may uniquely set the light emission time control signal according to the signal level of the correlation signal (i.e., the light emission time control signal that satisfies Equation 2) by using a look-up table in which a signal level of the light emission time control signal corresponds to the signal level of the correlation signal. However, the present invention is not limited thereto.

Also, based on the correlation signal output in operation S100, the image signal processing apparatus 100 sets an adjustment signal in each pixel according to the signal level of the correlation signal (operation S104). Here, for example, the image signal processing apparatus 100 may uniquely set the adjustment value according to the signal level of the correlation signal (i.e., the adjustment value that satisfies Equation 2) by using a look-up table in which the adjustment value corresponds to the signal level of the correlation signal. However, the present invention is not limited thereto.

The image signal processing apparatus 100 adjusts a gain of the input image signal based on the adjustment signal set in operation S104 (operation S106).

Although operations S104 and S106 are performed after performing operation S102 in FIG. 7, operation S102, and operations S104 and S106 may be performed independently. Thus, the image signal processing apparatus 100 may perform operation S102 in synchronization with operations S104 and S106 or may perform operation S102 after performing operations S104 and S106.

As illustrated in FIG. 7, in the image signal processing method, a correlation between current and previous frames is determined based on an input image signal and a gain of the image signal and a light emission time are controlled based on the determined correlation so as to satisfy a correlation represented in Equation 2. Thus, for example, according to the image signal processing method illustrated in FIG. 7, the image signal processing apparatus 100 may improve image quality by determining a correlation between current and previous frames based on an input image signal, and controlling a gain of the image signal and a light emission time based on the determined correlation.

(Display device 200)

The display device 200 will now be described as an image signal processing apparatus according to an embodiment of the present invention.

FIG. 8 is a block diagram of the display device 200 according to an exemplary embodiment of the present invention. The display device 200 illustrated in FIG. 8 is an exemplary display device according to the present embodiment of the present invention and the present invention is not limited to the structure illustrated in FIG. 8. Also, although it is assumed in the following description that an image signal input to the display device 200 is, for example, a digital signal to be used for digital broadcasting, the present invention is not limited thereto. The image signal input to the display device 200 may also be, for example, an analog signal used for analog broadcasting.

In the following description, an organic EL display device, that is, a self-emission type display device for emitting light according to a current flowing in a light emission element included in the organic EL display device, will be representatively described as the display device 200. However, the display device 200 is not limited to the organic EL display device and may be a display device such as an LCD device which may emit light according to a current flowing in a light emission element included in the LCD device.

Referring to FIG. 8, the display device 200 includes an image signal adjustment unit 202 and an image display unit 204.

Also, the display device 200 may include, for example, a display device control unit (not shown) such as an MPU for controlling the whole display device 200, a ROM (not shown) for recording a computer program or control data such as operation parameters, which is used by the display device control unit, a RAM (not shown) for primarily storing the computer program to be executed by the display device control unit, a display device memory unit (not shown) for storing, for example, data to be used when the image signal adjustment unit 202 adjusts an image signal, a display device manipulation unit (not shown) to be manipulated by a user, a reception unit (not shown) for receiving an image signal transmitted from, for example, a broadcasting station, and a communication unit (not shown) for communicating with an external device (not shown). The display device 200 may access each of the above components via, for example, a data transmission line such as a bus.

Here, the display device memory unit may be, for example, a magnetic recording medium such as a hard disk, or nonvolatile memory such as flash memory, however is not limited thereto. Also, the display device manipulation unit may be, for example, a manipulation input device such as a keyboard or a mouse, buttons, direction keys, or a combination thereof, however is not limited thereto.

Also, the display device 200 and the external device may be physically connected to each other, for example, by using a USB connection, or may be wirelessly connected to each other, for example, by using a WUSB connection. Furthermore, the display device 200 and the external device may be connected to each other, for example, through a network. Thus, the communication unit has an interface according to a connection method with the external device.

For example, the image signal adjustment unit 202 may have a structure that is the same as that of the image signal processing apparatus 100 illustrated in FIG. 3. Thus, the image signal adjustment unit 202 may determine a correlation between current and previous frames based on an input image signal and may control a gain of the image signal and a light emission time based on the determined correlation. Although not shown in FIG. 3, an image signal of which a gain is adjusted and a light emission time control signal are output from the image signal adjustment unit 202.

Based on the image signal and the light emission time control signal which are output from the image signal adjustment unit 202, the image display unit 204 displays an image represented by the image signal.

### [Exemplary Structure of Image Display Unit 204]

The image display unit 204 includes a display unit 206, a row driver 208, a column driver 210, a power supply unit 212, and a display control unit 214.

The display unit 206 includes a plurality of pixels arranged in a matrix form. For example, if an image is displayed at a standard definition (SD) resolution, the display unit 206 includes at least 640×480=307200 (data line×scan line) pixels. If a pixel includes R, G, and B sub pixels in order to display a color image, the display unit 206 includes 640×480×3=921600 (data line×scan line×the number of sub pixels) sub pixels. Likewise, for example, if an image is displayed at a high definition (HD) resolution, the display unit 206 includes 1920×1080 pixels. If a color image is displayed, the display unit 206 includes 1920×1080×3 sub pixels.

[Exemplary Application of Sub Pixels (Light Emission Element): Case When Organic EL element is Included]

If a light emission element including sub pixels of each pixel is an organic EL element, the light emission element has a linear IL characteristic, and thus, light is emitted according to a current applied to the light emission element. Thus, if the organic EL display device is used as the display device 200, a linear correlation may be formed between the light intensity of a subject, which is represented by an adjusted image signal, and the light emission intensity of light emitted from the light emission element of the display device 200, and thus, the display device 200 may display an image reliably for an image signal. Here, the organic EL element is a light emission element that emits light itself due to an EL phenomenon in which an electronic state of a material (the organic EL element) is changed from a ground state into an excited state due to an electric field and the differential energy caused when the unstable excited state returns to the stable ground state is emitted as light.

Also, the display unit 206 may include, for example, a pixel circuit (not shown) for controlling a voltage/current applied to each of pixels. The pixel circuit includes, for example, a switch device and a drive device for controlling a current by respectively using an applied scan signal and a voltage signal, and a capacitor for storing the voltage signal. The switch device and the drive device may be, for example, thin film transistors (TFTs).

For example, the row driver 208 and the column driver 210 allow each pixel of the display unit 206 to emit light by applying voltage signals to a pixel. Here, one of the row driver 208 and the column driver 210 may apply a voltage signal (scan signal) for turning a pixel on/off and the other of the row driver 208 and the column driver 210 may apply a voltage signal (image signal) according to an image to be displayed.

Also, the row driver 208 and the column driver 210 may be driven by using, for example, a dot sequential driving scan method of allowing each of the pixels arranged in the matrix form to emit light, a line sequential driving scan method of allowing each line of the pixels arranged in the matrix form to emit light, and a surface sequential driving scan method of allowing all of the pixels arranged in the matrix form to emit light.

Also, although the image display unit 204 of the display device 200 includes two drivers; particularly, the row driver 208 and the column driver 210 in FIG. 8, the display device 200 may include a single driver.

The power supply unit 212 supplies power to the row driver 208 and the column driver 210 applying a voltage to the row driver 208 and the column driver 210. The level of the voltage applied to the row driver 208 and the column driver 210 by the power supply unit 212 may be changed according to, for example, the image signal adjusted by the image signal adjustment unit 202.

The display control unit 214 may be, for example, an MPU. Based on the image signal and the light emission time control signal which are output from the image signal adjustment unit 202, the display control unit 214 inputs a control signal, for applying a voltage for turning a pixel on/off to the pixel, to one of the row driver 208 and the column driver 210, and inputs the image signal to the other of the row driver 208 and the column driver 210. Also, based on the image signal output from the image signal adjustment unit 202, the display control unit 214 may control the power supply unit 212 to supply power to the row driver 208 and the column driver 210.

Here, the display control unit 214 is an exemplary unit for controlling a light emission time and a light emission current (or a light emission voltage; hereinafter the same) to be applied to each light emission element of the display device 200. For example, as digital data, the image signal is transmitted to a driver for driving each pixel (which indicates one of the row driver 208 or the column driver 210; hereinafter the same), and a digital-to-analog (D/A) converter included in the driver converts the image signal to analog data so as to apply the converted image signal to each pixel. By changing a reference voltage used when the D/A converter performs digital-to-analog conversion, a light emission current to be applied to each light emission element may be changed without damaging a gray scale characteristic at, particularly, a low luminance. Also, for example, the driver changes data to be applied to each pixel to a single frame rate or a frame rate higher than the single frame rate and thus the display device 200 may control the light emission time by variably changing a frame rate and appropriately controlling a non-light emission time based on the light emission time control signal. Thus, the display device 200 may display an image represented by the image signal on a display screen while satisfying a correlation defined in Equation 2.

Due to the structure illustrated in FIG. 8, the display device 200 may correct an input image signal to display an image based on the corrected image signal and a light emission time control signal.

As such, the display device 200 includes the image signal adjustment unit 202 that has a function and a structure which are the same as those of the image signal processing apparatus 100 illustrated in FIG. 3. Thus, the display device 200 may determine a correlation between current and previous frames based on an input image signal and may adjust a gain of the image signal and adjust a light emission time based on the determined correlation. Also, the display device 200 such as an organic EL display device includes the image display unit 204 including a light emission element for emitting light according to a current. Thus, the display device 200 may display an image reliably for the adjusted image signal.

Accordingly, by determining a correlation between current and previous frames based on an input image signal and by controlling both a gain of the image signal and a light emission time based on the determined correlation, the display device 200 may prevent flickers and motion residual images and may improve image quality.

Although the display device 200 is described as an embodiment of the present invention, the present invention is not limited thereto. The present invention may be applied to, for example, a display device such as an organic EL display device or an LCD device, which includes a light emission element for emitting light according to a current or a voltage, and a reception device for receiving TV broadcasting signals.

### (Computer Program for Display Device 200)

A computer program encoded on a computer-readable medium and for allowing a computer to function as the display device 200 may improve image quality by determining a correlation between current and previous frames based on an input image signal, and controlling both a gain of the image signal and a light emission time based on the determined correlation.

While exemplary embodiments of the present invention have been described with reference to the attached drawings, the present invention is not limited thereto. It will be understood by one of ordinary skill in the art that various changes in form and details may be made therein within the scope of the present invention as defined by the following claims.

For example, even if an image signal input to the image signal processing apparatus 100 illustrated in FIG. 3 or the display device 200 illustrated in FIG. 8 is described as a digital signal, the input image signal is not limited to the digital signal. For example, the image signal processing apparatus 100 or the display device 200 may process an analog signal (image signal) by forming each of its respective components as an analog circuit.

The present invention can also be embodied as computer readable code recorded on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. In another exemplary embodiment, the computer readable recording medium can also be distributed over network coupled computer systems so that the computer readable code is stored and executed in a distributed fashion.

As described above, according to the present invention, image quality may be improved by determining a correlation between current and previous frames based on an input image signal, and controlling a gain of the image signal and a light emission time based on the determined correlation.

While the present invention has been particularly shown and described with reference to exemplary embodiments thereof, it will be understood by one of ordinary skill in the art that various changes in form and details may be made therein without departing from the spirit and scope of the present invention as defined by the following claims. Therefore, the scope of the invention is defined not by the detailed description of the invention but by the following claims, and all variations within the scope will be construed as being included in the present invention.

What is claimed is:

1. An image signal processing apparatus comprising:
a correlation determination unit which determines a correlation between a current frame, which represents an input image signal, and a previous frame in each of a plurality of pixels, and outputs a correlation signal of a signal level according to a determination result;
a light emission time setting unit which selectively outputs a light emission time control signal that defines a light emission time in one frame period, based on the correlation signal;
an adjustment value setting unit which selectively outputs an adjustment value that adjusts a gain of the image signal, based on the correlation signal; and
a gain adjustment unit which adjusts the gain of the image signal based on the adjustment value and outputs the image signal of which the gain is adjusted,
wherein the light emission intensity in one frame period, which is defined by a product of a light emission time corresponding to the light emission time control signal and a signal level corresponding to the image signal output from the gain adjustment unit, is uniform regardless of the determination result of the correlation determination unit.

2. The image signal processing apparatus of claim 1, wherein the correlation determination unit comprises:
a frame memory which stores the input image signal in one frame period of the previous frame; and
a comparison unit which compares an image signal corresponding to the current frame to an image signal corresponding to the previous frame output from the frame memory, in each of the pixels, and outputs the correlation signal according to a comparison result.

3. An image signal processing method comprising:
determining a correlation between a current frame, which represents an input image signal, and a previous frames, in each of a plurality of pixels, and outputting a correlation signal of a signal level according to a determination result;
outputting a light emission time control signal that defines a light emission time in one frame period, based on the correlation signal;
outputting an adjustment value that adjusts a gain of the image signal, based on the correlation signal; and
adjusting the gain of the image signal based on the adjustment value and outputting the image signal of which the gain is adjusted.

4. A computer-readable medium encoded with a computer program for causing a computer to execute an image signal processing method, the method comprising:
determining a correlation between a current frame, which represents an input image signal, and a previous frame, in each of a plurality of pixels, and outputting a correlation signal of a signal level according to a determination result;
outputting a light emission time control signal that defines a light emission time in one frame period, based on the correlation signal;
outputting an adjustment value that adjusts a gain of the image signal, based on the correlation signal; and
adjusting the gain of the image signal based on the adjustment value and outputting the image signal of which the gain is adjusted.

5. A display device comprising:
an image signal adjustment unit which adjusts both a gain of an image signal and a light emission time in one frame period, based on an input image signal; and
an image display unit having at least one pixel that comprises a light emission element that emits light according to a current, and which displays an image based on an adjusted image signal and a light emission time control signal that defines the light emission time, wherein the adjusted image signal and the light emission time control signal are output from the image signal adjustment unit,
wherein the image signal adjustment unit comprises:
a correlation determination unit which determines a correlation between a current frame, which represents an input image signal, and a previous frame, in each of a plurality of pixels, and outputs a correlation signal of a signal level according to a determination result;
a light emission time setting unit which selectively outputs the light emission time control signal based on the correlation signal;
an adjustment value setting unit which selectively outputs an adjustment value that adjusts the gain of the image signal, based on the correlation signal; and
a gain adjustment unit which adjusts the gain of the image signal based on the adjustment value and outputs the adjusted image signal of which the gain is adjusted, and
wherein the light emission intensity in one frame period, which is defined by a product of a light emission time corresponding to the light emission time control signal and a signal level corresponding to the image signal output from the gain adjustment unit, is uniform regardless of the determination result of the correlation determination unit.

6. A display device according to claim 5, wherein the light emission time setting unit includes a switch to be selectively connected to a different light emission time control signal of a plurality of light emission time control signal according to the correlation signal, and
the adjustment value setting unit includes a switch to be selectively connected to a different adjustment value of a plurality of different adjustment values according to the correlation signal.

7. A display device according to claim 5, wherein each pixel of the image display unit emits light according to one of at least three light emission states selected by the image signal adjustment unit based on a correlation level of the determination result, and the adjustment unit outputs the correlation signal of the signal level which corresponds to the selected light emission state.

8. A display device according to claim 7, wherein the at least three light emission states include an impulse light emission state, a hold type light emission state, and at least one intermediate light emission state,
a different light emission time of a plurality of light emission times corresponds to each of the at least three light emission states, and
a different signal level of a plurality of signal levels corresponding to image signals output from the gain adjustment unit corresponds to each of the at least three light emission states.

9. A display device according to claim 8, wherein a light emission time setting unit selectively outputs the light emission time control signal based on the light emission time corresponding to the selected light emission state, and
an adjustment value setting unit selectively outputs the adjustment value that adjusts the gain of the image signal to the signal level corresponding to the selected light emission state.

10. A display device according to claim 9, wherein, if the correlation level has a maximum value, the image signal adjustment unit selects the hold type light emission state,
if the correlation level has a minimum value, the image signal adjustment unit selects the impulse type light emission state, and
if the correlation level has an intermediate value, the image signal adjustment unit selects one of the at least one intermediate light emission states corresponding to the intermediate value in a look-up table.
